(19) United States
(12) Patent Application Publication
(10) Pub. No.: US 2006/0201687 A1
(43) Pub. Date: Sep. 14, 2006

(54) Self-contained automated residential fire extinguisher

(76) Inventor: Stanley Jonathan Fortenberry, San Angelo, TX (US)

Correspondence Address: STANLEY J. FORTENBERRY, 221 S. ABE ST, SAN ANGELO, TX, 76903, US

(21) Appl. No.: 11/065,611

(22) Filed: Feb. 25, 2005

(51) Int. Cl. A62C 35/00

(52) U.S. Cl. 169/16; 169/37; 239/209

(57) ABSTRACT

The below describes a self contained, easy installable fire-extinguishing device having a pressurized cylinder containing a fire extinguishing agent or compound, e.g., halon, CO₂, H₂O or other fire extinguishing substance. The cylinder shall be elongated metal (aluminum, steel, or other metal). The system is activated by a heat sensitive spray nozzle. Upon the heat sensitive nozzle causing activation of the system, the fire extinguishing agent is delivered through a high pressure hose and emitted through the spray nozzle at the end of the hose. References Cited
U.S Patent Documents

| | | | |
|---|---|---|---|
| 5868205 | February, 1999 | Cunningham, et al. | 169/65 |
| 20020112863 | August, 2002 | Padgett, Randall; et al. | 169/56 |

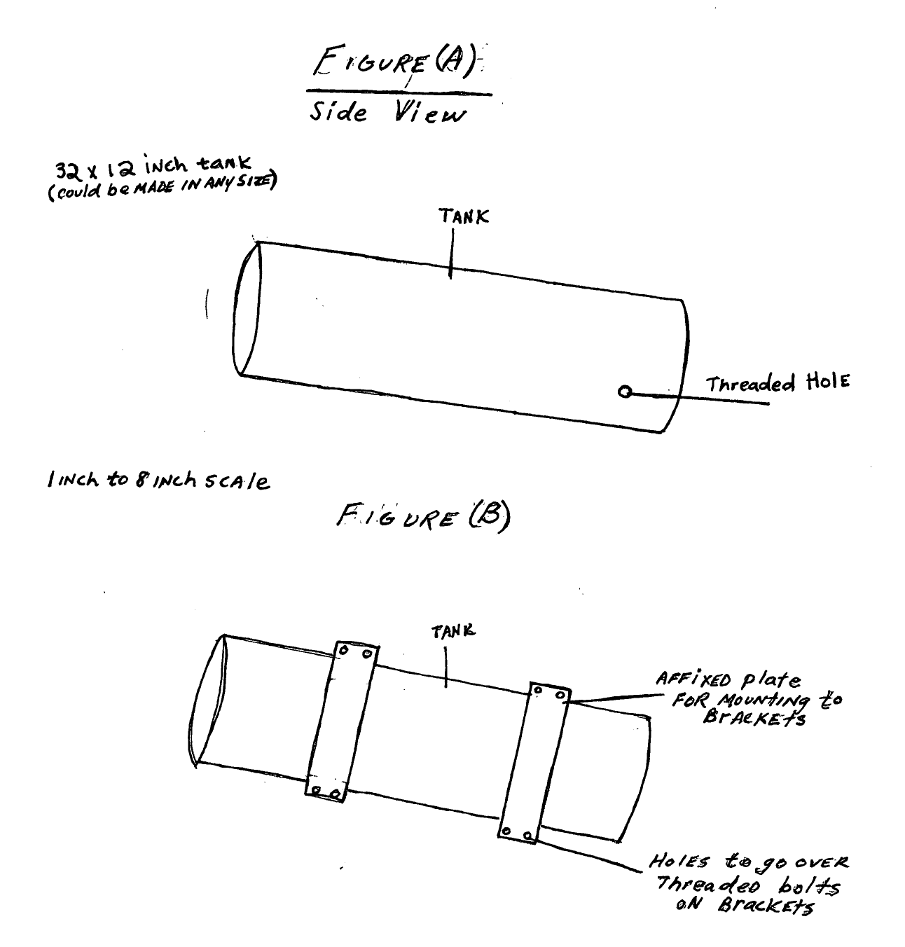

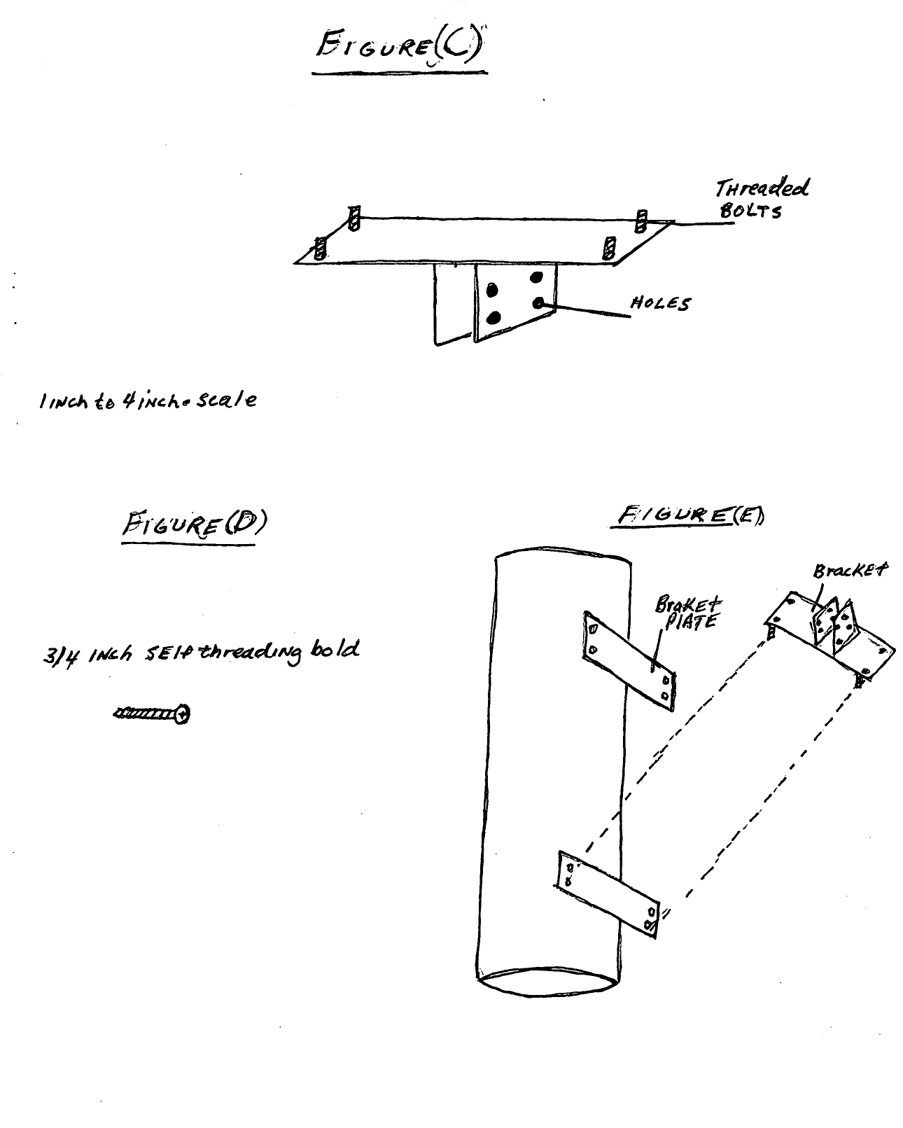

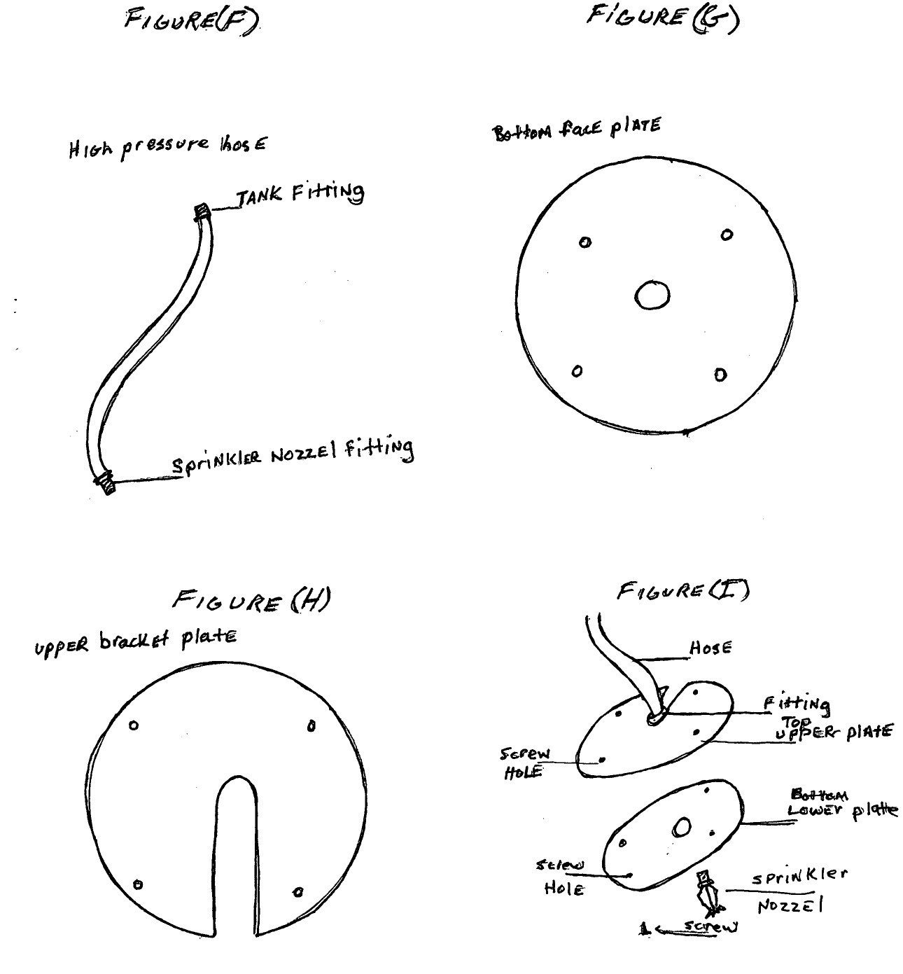

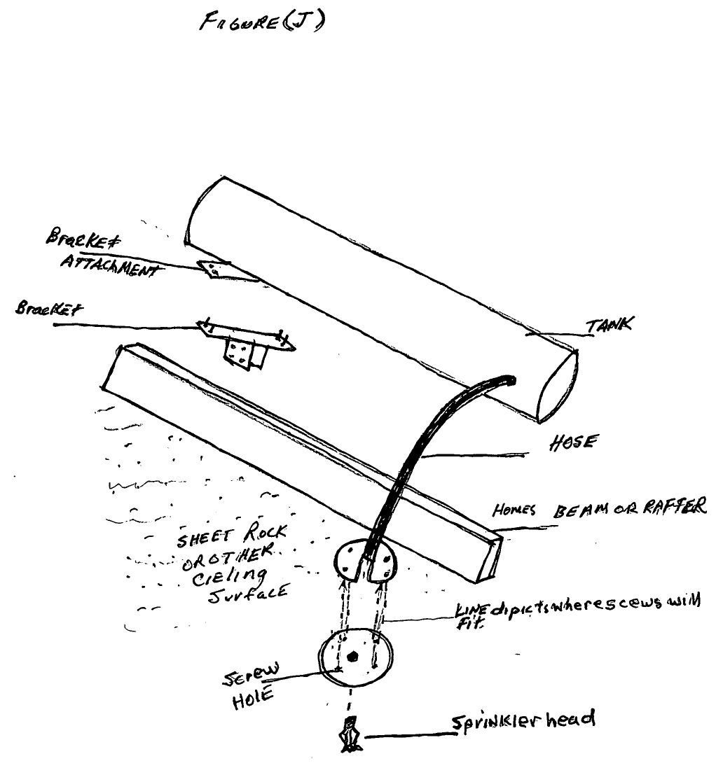

### TECHNICAL FIELD OF THE INVENTION

The present invention relates to a fire-extinguishing system, method and apparatus that provides highly effective, self-induced fire elimination for residences and small businesses. More particularly, the invention allows small businesses and homes the ability to have a cost-effective, easy to install apparatus for extinguishing fires.

### BACKGROUND

Traditionally, small businesses and homes have been void of the sprinkle systems found in larger businesses and thus innumerable amounts of damage to property and loss of human life has occurred. This is primarily due to the fact that small businesses and homes cannot afford the cost associated with plumbing, installation and materials required for having a sprinkle system. Furthermore, currently when a home or small business catches fire, it requires firefighters and others to be exposed to danger. Additionally, the excessive amounts of water being utilized by traditional fire fighting means often creates much damage in itself. This results from the time gap between when the fire is reported and the arrival of the fire fighters i.e. the fire spreads rapidly in these precious minutes awaiting fire fighters arrival. Finally, it is well known that extinguishing a fire quickly and effectively will eliminate property loss and potential harm to humans and pets.

### SUMMARY OF THE INVENTION

The present invention is meant to solve the aforementioned problems associated with current methodologies available for extinguishing fire. This invention provides the capability of eliminating most fires in residences and small businesses prior to excessive damages. That is, this invention provides an affordable way for homes and small businesses to install a sprinkle and fire-extinguishing apparatus.

### BRIEF DESCRIPTION OF THE FIGURES

The system will consist of an operation based on a pressurized tank to heat activated sprinkler nozzle. The tank will mount on the rafter or beam in the attic of the house. Most beams are 2 by 6 or 2 by 4 timber beams. Our brackets are designed to accommodate those as well as steel rafters.

(Figure A) Fire extinguishing chemical Holding tank, further, the holding tank is either steal, aluminum, or other strong suitable material.

(Figure B) Bottom view of holding tank with mounting plates

(Figure C) This bracket connects to the beam or rafter and holding tank of the extinguisher using threaded screws to connect to the beam or rafter and connect to the plate on holding tank with bolt and nut.

(Figure D). Example of ordinary threaded screw and nuts

(Figure E). This illustrates the side view of holding tank and mounting bracket.

(Figure F) A high-pressure hose connects to the tank by threaded fitting.

(Figure G). Bottom cover plate Figure H top cover plate will hold sprinkler nozzle in place

(Figure I). The high-pressure hose then attaches to top cover plate through bottom cover plate to the sprinkler nozzle hose fitting will thread on to sprinkler nozzle

(Figure J) Illustration of unit being assembled.

1. The tank attaches to rafter depending on ceiling type.
2. High pressure hose goes from tank to sprinkler nozzle
3. A two piece cover plate is used to sandwich the ceiling surface
4. Sprinkler head is connected to hose

1. A fire extinguishing system using a cylinder designed to be attached with brackets to rafters, joist or beams having a simple installation procedure;

2. A fire extinguishing system according to claim 1, wherein brackets are attached to the rafter or beam;

3. A fire extinguishing system according to claim 1 and 2 providing a flexible high-pressure hose designed to protrude through a small whole cut in the ceiling substance;

4. A fire extinguishing system according to claim 1, 2 and 3 having mounting plates-brackets that attach to hose fitting by means of tongue and groove or threads. This plates-brackets remain in upper side of the ceiling;

5. A fire extinguishing system according to claim 1, 2, 3 and 4, wherein a face plate with a hole in the center allows the hose fitting to protrude the previously mentioned in claim 4 plates-brackets using screws.

6. The ceiling substance will be sandwiched between the plates-brackets and the face plate;

7. A fire extinguishing system according to all of the above claims, wherein a heat-sensitive sprinkle nozzle will be attached to the high pressure hose fitting protruding through the plates-brackets, the ceiling and the face plate.
